(19) United States
(12) Patent Application Publication
(10) Pub. No.: US 2006/0116914 A1
(43) Pub. Date: Jun. 1, 2006

(54) Method and system of identifying available reserve and subrogation funds for workers' compensation insurance carriers

(76) Inventor: Gordon A. Stemple, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/326,948

(22) Filed: Jan. 5, 2006

Related U.S. Application Data
(63) Continuation-in-part of application No. 10/938,204, filed on Sep. 10, 2004.
(60) Provisional application No. 60/510,624, filed on Oct. 10, 2003.

(51) Int. Cl. G06Q 40/00

(52) U.S. Cl. 705/4

(57) ABSTRACT

A method and system to allow workers' compensation carriers to identify reserve and subrogation funds that are available due to unreported settlements or other resolutions of third party claims filed by a workers' compensation claimant. The method includes the steps of selecting pre-defined categories of workers' compensation claims to review for possible reserve and subrogation funds, reviewing the carrier's data to identify those claims that fit within the selected categories, obtaining responses for each of the identified claims by use of form interrogatories transmitted to the claimant and/or information from private or public files or databases, analyzing the responses to separate them into appropriate responsive categories and then using the response information to identify any available reserve and subrogation funds. The information obtained from the responses is used to reduce the carrier's reserve fund requirement, to reduce or stop payments to claimants or for other uses beneficial to the carrier.

### CROSS-REFERENCE TO RELATED APPLICATIONS

This application is a continuation-in-part of U.S. patent application Ser. No. 10/938,204 filed Sep. 10, 2004, which claims the benefit of U.S. Provisional Application No. 60/510,624 filed Oct. 10, 2003.

### BACKGROUND OF THE INVENTION

A. Field of the Invention

The field of the present invention relates generally to business methods and systems that are useful for updating factual information that is subject to change over time. More particularly, the present invention relates to an improved method and system of identifying whether funds that were previously unavailable have become available due to a change in the circumstances that control those funds. Even more particularly, the present invention relates to such methods and systems that are useful for workers' compensation insurance carriers and others to identify if funds previously placed in reserve accounts are available for other non-reserve uses and if unreported or unidentified third party settlements have occurred for purposes of obtaining subrogation recoveries or asserting credits against future payment obligations.

B. Background

As is well known in the business and insurance industries, employers and their employees who are injured while working for the employer are subject to a workers' compensation system that strives to create a balance between the cost and predictability to the employer and compensation to the injured worker. Although most jurisdictions have a legislative scheme that defines the overall protection afforded to employers and their injured workers, the basic system is a private, non-governmental approach that primarily relies on private funding sources for the workers' compensation system. The funding for the workers' compensation system comes from two sources, one being the employer who chooses and is able to be self-insured and the other being workers' compensation insurance companies or carriers (hereinafter for purposes of simplifying this disclosure, self-insured employers and insurance companies are collectively referred to as “carriers”). Basically, the workers' compensation system is that employers agree to pay, either themselves or through their insurance company, benefits to injured, disabled or killed workers who are injured or die as a result of their employment, and the workers agree to accept that system as the exclusive remedy against their employer. This system substantially reduces the need for injured workers to bring tort or other lawsuits against their employer to obtain financial coverage of their medical and other costs associated with the injury and reduces the employer's uncertainty and costs with regard to having to defend against such lawsuits. The general goal of the system is to provide more certain and immediate compensation to the injured worker so that he or she may obtain the medical care and financial assistance needed and to limit the exposure of any one employer to the costs associated with providing the necessary compensation. In general, workers' compensation programs also provide limited scheduled awards for disability (temporary and permanent) and provide unlimited medical treatment as needed, unless or until resolved by settlement with the workers' compensation carrier.

Most, if not all, states have specific laws and regulations affecting the operation of their workers' compensation system. Typically, an administrative agency regulates workers' compensation laws. In California, as an example, the relevant agency is the Workers' Compensation Appeals Board or WCAB. Most states have similar administrative agencies. In general, the state agencies and the laws which regulate them, for the purposes of this methodology, are quite similar. For purposes of simplifying the discussion herein, the WCAB and the appropriate California laws will be referenced as examples of the administrative law systems and subrogation statutes relevant to the method and system of the invention disclosed herein. As known to those skilled in the art, the laws and regulations of other states will be applicable to this invention as necessary.

All workers' compensation insurance carriers must comply with regulatory laws that require them to place funds in a reserve account sufficient to back the estimated benefits due for each industrial accident injury claim (the injured worker's compensation claim) filed against them by employees of their insureds. The reserved funds must remain in place until the claim it covers is closed. Large multi-state or national workers' compensation carriers may have billions of dollars deposited in their reserve accounts. Even smaller carriers may have hundreds of millions of dollars in their reserve accounts. Most states allow the carrier to take a credit against future benefits the carrier owes in a number of situations. One such situation is where an employee who is injured in an industrial accident, as an example, has made a workers' compensation claim and has also brought a lawsuit stemming from the same injury event against one or more “third party” defendants. One common example is where a worker driving an employer's automobile in the course and scope of his or her employment is rear-ended by a vehicle belonging to another person or company causing injury to the employee. The bringing of one claim, such as a negligence claim against the driver of the automobile causing the accident, does not exclude the other claim, such as a workers' compensation claim.

The amount of a third party recovery, when successfully resolved by settlement or court proceeding, usually provides a much larger monetary recovery to the worker than he or she will realize from the workers' compensation claim. This is primarily because the civil court claim allows damages to be sought against the third party defendant(s) for a much broader scope of damages than are allowed under the workers' compensation system. Naturally, this assumes the injured worker has a good third party case and that the third party defendant has ample insurance and/or assets with which to pay the third party claim. To prevent the injured worker from realizing a double recovery, as well as for other reasons, most states allow the carrier to recover some or all of the benefits that it has paid to the injured worker, either by suing the third party defendant(s) directly, by filing a complaint in intervention in the injured worker's third party case, by filing a statutory lien (generally not very effective where contributory negligence or comparative fault is alleged as an affirmative defense by a third party defendant), or by seeking seeking to impose a constructive trust against the funds recovered by the injured worker when the injured worker failed to comply with the statutory duty to give notice to the employer and/or carrier that a third party case has been filed and/or a settlement was pending between the worker and the third party defendant(s) providing sufficient time for the carrier to legally protect its subrogation interests. Both the carrier and the injured worker can, by agreement, be represented by common counsel in the case against the third party defendant(s). Most states allow a bar to or some reduction in the carrier's subrogation recovery or right to claim a credit against future benefits owed where the employer's contributory negligence or comparative fault is a proven cause of the worker's injury.

The injured worker is required by state or federal law to give notice to the employer and/or carrier of a pending third party lawsuit if one has been filed and in advance notice of any pending third party settlement, before the settlement is finalized, so the carrier has sufficient time to protect its subrogation interests. Using one of the processes mentioned above, or combinations of them as applicable, the carrier may seek recovery of funds equal to the benefits it has paid to the injured worker or if the worker's net settlement or third party litigation resolution exceeds that amount and the carrier is required to pay additional benefits over time to the injured worker, it may also seek to obtain a future credit against some or all of the unpaid benefits owed. Where the carrier has learned of an injured worker's third party settlement and obtained a credit against future benefits owed, the state law of most jurisdictions allows the carrier to both remove from its reserved funds an amount equal to the credit granted and stop paying benefits to the injured worker until the credit is exhausted.

As a general rule the sooner an injured worker's third party settlement is discovered by the carrier, the greater the benefits the carrier can obtain. For example, the earlier in the pendency of an injured worker's third party claim an undisclosed third party settlement is discovered the less likely the injured worker is to vigorously assert, at the WCAB or equivalent state agency, the allegation that the employer's negligence or comparative fault should reduce the amount of any future credit awarded the carrier. The reason for this is that if the injured worker is successful in proving the employer's contributory negligence or comparative fault before the WCAB, this finding may become a binding determination of the same issue before the trial court, causing a greater reduction in the larger sum a liable third party defendant would otherwise be obligated to pay absent such finding. Should the undisclosed settlement be discovered after the last third party defendant's liability is resolved, in multi-defendant third party cases, out of the injured worker's court claim, the injured worker is more likely to vigorously allege the employer's contribution to the causation of his or her injury because by then there would be no or less potential third party funds forthcoming to be reduced by a finding in the injured worker's favor (against the employer). In all cases where the workers' compensation carrier's reserves have been lawfully compliant, the carrier should be able to reduce its reserve account in an amount equal to the injured worker's net recovery or the allowed credit, whichever is less, from each partial or total third party settlement.

Earlier discovery of undisclosed settlements/resolutions of injured worker third party claims, not only makes it more likely that the carrier will obtain fuller mass subrogation recoveries and future credits, but the credits obtained will for a period of time, perhaps years, abate the carrier's duty to continue paying benefits to the injured worker. Early discovery of non-disclosed third party settlements in some jurisdictions opens a statutory door for the injured workers to become responsible to pay certain litigation expenses of the carrier, an additional leverage position in favor of the carrier. In addition, early discovery of non-disclosed third party settlements, or funds obtained by court resolutions, generate a more encouraging environment for the carrier to become engaged in both compensation and/or third party subrogation discussions with the injured worker's legal representatives. When benefit payments stop, or may stop, the attorney representing the injured worker is more likely to contact the carrier to see what can be done to cause the benefit payments to continue. This early contact, at a time when the injured worker and carrier both need something from each other, may afford an opportunity to conclude the workers' compensation case and/or reach an amicable resolution of the subrogation issues, by way of various settlement mechanisms, including a stipulated lien agreement (discussed in more detail below).

Presently, the primary mechanisms by which a workers' compensation insurance carrier obtains factual information from an injured worker is by deposition in the workers' compensation case, by way of an “Employer's First Report of Injury” (hereafter “First Report(s)”) and/or by a form letter mailed to the injured worker. As is well known, depositions in these types of cases are quite expensive, in part because the carrier must pay the attorney fees of its own and the injured worker's counsel. In those workers' compensation cases where a deposition is taken, the timing of the deposition may be less than beneficial. That is to say, the deposition may occur at a time when no third party filings, settlement(s) or case resolutions may have taken place, so none will be identified in the deposition. Most jurisdictions limit the number of depositions to which the injured worker may be subject to one, absent a showing of good cause. As a result, the injured worker's deposition is not taken in all cases where third party resolutions may have occurred. Instead of utilizing depositions, most workers' compensation carriers send out form letters at or near the time each industrial injury is first reported asking the injured worker if a third party claim has been filed and/or a law firm retained to pursue a third party claim, and if so, to inform the carrier of the identity of the attorney or law firm. In general, this is not very effective tool for revealing non-disclosed filings or settlements. Also, most carriers do some limited review of the First Reports. The injured worker generally receives these letters too early in the process, namely before hiring legal counsel and certainly well ahead of most third party settlements or case resolutions. Reviewing the First Reports is usually a flawed detection method because it is also too close to the event and contains insufficient information to disclose many potential third party scenarios. As a result, the injured worker can honestly answer no to the questions posed by the letter and a week later change his or her mind and hire a third party plaintiff attorney and/or file a lawsuit. In many states the injured worker is not absolutely prevented from making third party settlements without the consent of the carrier or employer and, therefore, has no enforceable ongoing duty to update the carrier if his or her circumstances change in the future, absent administrative or judicial process requiring current disclosure.

The current state of the art in most carrier's workers' compensation subrogation procedures is not to be aggressively proactive in uncovering non-disclosed third party recoveries on an individual, and certainly not on a mass discovery, basis. Information about the existence of undisclosed settlements and/or awards in the injured worker's third party case, as a rule, is not discovered until the injured worker's deposition is taken by one or more third party defendants, which usually takes place shortly before the third party case is set for trial. Often, this deposition is not attended by subrogation counsel because the third party action itself was not disclosed, initially discovered by the carrier, or because the carrier did not want to expend the funds required to have an attorney representing its own interests present at the deposition, even where the carrier received statutory notice of the date and place it would be taken. The reality is that this late discovery pattern greatly lessens the injured worker's motivation to work in cooperation with the carrier, rather it promotes an alliance between the injured worker and third party defendant, actual or in effect, to join forces in an effort to diminish the carrier's subrogation interests. In many cases the injured worker's deposition is not taken in the third party case, for example when liability and injury are not disputed, a settlement is reached because the available third party's insurance is less than the agreed value of the claims, or for many other reasons.

A significant number of newly filed workers' compensation claims escape identification by carriers as claims likely to engender third party liability when the claim is initially presented to it by way of the First Report. When the First Report is received by the carrier, sent to it by its insured (the employer) and/or the employer's injured worker, many carriers rely on workers' compensation claim adjusters or supervisors to spot potential third party involvement and/or the potential for the injury to be defined as “catastrophic” (a word of art in the workers' compensation industry meaning, in essence, that the claim poses a major financial risk to the carrier and often the coverage provided by its reinsures, however, for purposes of this methodology a catastrophic claim or injury is specifically defined below) from a quick review of these usually abbreviated one or two page fill-in-the-blank First Reports. The workers' compensation carrier's adjusters and claim supervisors are traditionally not well trained in basic principals of personal injury tort law. Their primary focus is on the task of managing and resolving workers' compensation claims in a timely manner least costly to the carrier. Most carriers are members of or subscribers to a claims reporting service(s) that requires reports of claims against its insured's to be reported to it for entry in its accumulated database. Most of these service providers accumulate national databases of claims reported to them by their member carriers, which sell casualty, property, auto, marine, errors and omissions and other lines of insurance. They included traditional court service and investigation providers. For the sake of simplicity in this application this type of service provider will be referred to as a Claims Report Provider(s).

When a workers compensation or any other kind of carrier receives a first report of injury or otherwise becomes aware that a claim is being presented against one of its insured's it provides basic information about that claim to the Claims Report Provider(s), including date of injury, type of injury or loss, the address of the claimant, social security number, and other basic claims identification information. It is sometimes required to do this as a contractual term of the carrier's membership between it and the Claims Report Provider(s). Each member carrier must report each new workers compensation claim or much the information that appears on the carriers' First Report of Injury form shortly after it is received. When the Claims Report Provider(s) receives this information it, in turn, generally a matter of days, reports back to the initiating workers compensation carrier all claims in its data base which appear to have been presented by a similarly identified individual(s) to the individual identified in its First Report of Injury.

The purpose for this reporting back of all known claims, which often includes stolen car claims, property loss home owners claims, basically whatever has been reported to the Claims Report Provider(s) by individuals with similar identification data, is primarily to provide a tool to the workers compensation claims adjuster or examiner to help spot insurance fraud. In addition this process helps verify what are commonly referred to in the industry as continuing trauma cases, for example carpal tunnel injuries. If a continuing trauma claimant moves from employer to employer or the employer changes carriers such claims need not be scrutinized with the same level of investigation to determine the authenticity of injury. Also, this information allows for allocation of liability for such claims among different carriers.

By themselves the reports of Claims Report Provider(s) are not a reliable source for detecting subrogation claims or unreported subrogation claims. The information is provided to soon after the workers compensation carrier receives its First Report of Injury. The decision to pursue a third party claim may not be made fore more than a year after the occurrence of the industrial accident to which the third party activity is related. The information provided will likely be too broad in spectrum, fragmented, including irrelevant claims and claims filed by people with similar names who may be utilizing the same social security number for the sake of obtaining work such as illegal residents or people with no valid social security number. Reports supplied may be the result of data entry errors. Though these Claims Report Provider(s) do provide a valuable service to the insurance industry to detect fraud and for other purposes, they have not in the past, nor do they given the present state of the art within the industry, provide data which by itself is very useful as a source for identifying or verifying large prescreened lots of claims files for the existence of third party claim activity. Claims Report Provider(s)' report data are unlikely, absent its use as an integrated part or component of the present methodology and invention, to provide any meaningful utility for such a purpose. Some of the Claims Report Provider(s) databases are directly searchable through the Internet. However, unless the searcher is intentionally seeking a personal injury, wrongful death or medical malpractice third party claim associated with or having a nexus to the original industrial accident that connection is highly unlikely to take place, but for on a serendipitous hit and miss basis over a number of years. The searcher would figuratively be receiving a haystack of materials not knowing why nor what the needle is which needs to be found for the required connection to be made.

The present state of the art in the workers compensation industry is not to detect previously unreported and unexpected subrogation files, let alone to utilize Claims Report Provider(s)' databases or services to find or locate third party activity related to large numbers or blocks of workers' compensation claims files which have been submitted to it already categorized, prescreened and determined to be files likely to produce a high yield of previously undetected third party claims. As a result, a considerable number of potential third party claims are missed in the present ineffective screening process.

Unfortunately, failing to identify the subrogation potential of many claims filed against carriers is by far the norm and current state of the art in the workers' compensation industry. Some carriers have initial or concurrent initial First Report reviews by in-house subrogation departments, as well as by claims supervisors and adjusters. Even so, many potential third party claims are still missed because most of these inquiries go no further than a review of the First Report forms, which in many instances minimize the degree of injury incurred where the only physician to have examined the injured worker when the First Report was filled out was selected by the employer. Failing to recognize obvious third party claims from First Reports is just one more example of why workers' compensation carriers generally fail to identify potential third party involvement or identify subsequent settlements or court resolutions, which would otherwise entitle them to seek a future credit or obtain other overall claims resolution benefits. A handful of carriers attempt to avoid the accumulation of undetected third party settlements by not providing coverage, at any price, to those companies and industries likely to incur catastrophic, mass injury and/or reserved for rehabilitation claims, as defined herein. This however, does not solve the problems experienced by the vast majority of carriers whose underwriting policies have not been that selective in the coverage they have sold.

The state of the art in the workers' compensation insurance industry is to generally miss becoming aware of the existence of a very significant number of unreported third party settlements and case resolutions made on behalf of injured workers whose workers' compensation claims are still pending or which should be, but have erroneously been closed vitiating or effectively abandoning the carrier's subrogation rights. As a result, vast sums of money are needlessly deposited in the carriers reserve accounts and often stay there for years. Benefit payments which could otherwise be halted until credits equal to these settlements or awards are exhausted, continue unnecessarily to be paid. To the extent these events negatively impact the amount of funds deposited in a carrier's general account, because they are instead placed in its reserve account, the carrier's ability to continue selling new coverage in multiples of its freely held funds and earn new premium profit is thwarted. The carriers own self-interest and duty to its stockholders mandate that they discover these undisclosed settlement/court resolution funds. The resulting credits should either be utilized to free up unnecessarily committed reserve funds and stop payment of benefits claims until the respective credits are exhausted and/or used to take longer range advantage of the earlier discovery of them (or discovery at all) to resolve the workers' compensation and subrogation claims to which they relate on terms more beneficial to the carrier.

Yet another downside of failing to discover these funds and obtain the appropriate credits affect the carrier's insureds, to whom they owe contractual and fiduciary duties. Many workers' compensation policies provide for the issuance of dividends back to the insured to reward the insured for having a lower loss record during the prior coverage period. When the carrier does not act to discover the unreported settlement(s), thus resulting in a recovery of benefits paid and a possible credit to stop continuing payment of benefits on a given insured's account, the carrier increases the chances that the proper dividend payable to its insured will not be paid. In fact, instead of receiving a dividend the insured may be penalized by the assessment of a higher risk rate, resulting in an increased premium rate or even a refusal to renew its coverage for the subsequent coverage period. A large workers' compensation carrier with billions of dollars in its reserve account(s) may have hundreds of millions of dollars which should be shaken loose for the benefit of its stockholders, insureds and its own self-interest. The stockholders, insureds, injured workers and self-interests of smaller carriers may face a greater negative effect by failing to take affirmative action as now enabled by the methodology of the present invention. As seen recently in California, many workers' compensation carriers, in the face of economic hardships resulting from a number of reasons, have failed. This shifts their duty to pay claims to the public via the processes of the California Insurance Guarantee Association, which costs are eventually passed along to the future workers' compensation insurance purchasing public. Shareholders are often irreparably financially injured when the carrier is liquidated. Perhaps some of these companies could have made a financial recovery or comeback had the method and system of the present invention been available and applied in years past.

Despite the apparent advantages of identifying undisclosed settlements and case resolutions, it is still the state of the art in the workers' compensation industry not to affirmatively act on a mass scale to uncover, in one cost effective effort, what is believed to be massive sums of undisclosed third party settlement and case resolution funds. Until now, a cost effective methodology to accomplish this task has not been formulated. The practice and state of the art in workers' compensation and third party litigation do not easily facilitate the discovery of undisclosed third party settlements and case resolutions except on a one at a time, slow, hit and miss basis. When these discoveries are made, if at all, they are usually discovered at a time when the carrier has lost most of its settlement leverage, such as when the third party case is near conclusion or has been concluded. What is needed is a method and system that provides a workers' compensation carrier with a simple, efficient and cost effective procedure to uncover the likely millions of dollars in undisclosed settlements, halt the payment of millions of dollars in benefits in those cases where the discovery of undisclosed fund recoveries justify obtaining a credit, free the funds from the carrier's reserve account and/or provide workers' compensation carriers an opportunity to resolve many thousands of underlying workers' compensation and subrogation claims earlier and on terms beneficial for the carrier.

### SUMMARY OF THE INVENTION

The method and system of identifying available reserve funds for workers' compensation insurance carriers of the present invention solves the problems and provides the benefits identified above. That is to say, the present invention discloses a new and improved method and system of effectively and easily identifying funds that are allowed to be freed from reserves due to previously undisclosed third party lawsuits and/or settlements and funds that are available for subrogation recovery due to unreported or unidentified third party settlements. The method and system of the present invention provides the carrier with a simple, efficient and cost effective methodology and system specifically designed to uncover millions of dollars in undisclosed settlements, halt the payment of millions of dollars in benefits in those cases where the discovery of undisclosed fund recoveries justify obtaining a credit, free the funds from the carrier's reserve account and/or provide workers' compensation carriers an opportunity to resolve many thousands of underlying workers' compensation and subrogation claims on beneficial terms earlier on in both workers' compensation and civil court arenas. Positive results may be seen if this methodology is properly and vigorously followed by the carrier within a few short months for many thousands of pending workers' compensation cases.

In a preferred embodiment of the present invention, the method of identifying a source of available reserve funds for a workers' compensation insurance carrier, including self-insured employers, is initiated by selecting one or more categories of workers' compensation claims to review for the source of available reserve funds. In the preferred embodiment, the categories include mass injury claims, catastrophic injury claims and reserved for rehabilitation claims. Once the categories are selected, the carrier reviews its workers' compensation data to identify a plurality of workers' compensation claims that can be categorized within the selected categories. Utilizing the selected categories, the carrier then obtains information, referred to as responses, from the claimants in the categories by transmitting interrogatories to the claimants, or their attorneys, and/or by utilizing private and public online and off-line databases or other resources, including traditional sources of claims filing information. When utilizing interrogatories, the carrier then transmits an interrogatory questionnaire to the claimant or claimants in each of the workers' compensation claims. If the claimant is represented by an attorney, the carrier transmits the interrogatory questionnaire to the claimant through the attorney. Preferably, the interrogatory questionnaire comprises a set of interrogatories, each seeking a response from the claimant, that are directed to the identification of one or more third party claims filed by the claimant. In some circumstances, it will be in the carrier's best interest to prepare an interrogatory form and seek approval of the form interrogatories from the relevant legal tribunal prior to sending out the interrogatories to the claimants. This pre-approval will reduce or eliminate potential objections from the claimant to the interrogatories. In some jurisdictions, however, the law is changing or does not currently allow or enforce the use of interrogatories in administrative proceedings such as workers compensation adjudications. In those jurisdictions (as well as in interrogatory-allowed jurisdictions), the carriers will compare their files that have been identified as Catastrophic, Mass Injury Claims and/or Reserved for Rehabilitation Claims to insurance claims information obtained from the Insurance Index Bureau, ISO Tech, Marine Index Bureau and/or other online and off-line claims filing information sources, including traditional court service companies and services to identify subsequent third party personal injury or wrongful death lawsuits alleging facts with sufficient particularity to identify them as being related to the underlying industrial accident. Hereinafter, the use of claims filing information sources, whether online databases or traditional off-line sources, will be referred to as the “subsequent claims reporting comparison approach” and the information obtained therefrom will be referred to as “responses” (as with the information obtained from interrogatories). Once the carrier receives the responses to the interrogatories and/or pursuant to the subsequent claims reporting comparison approach, it should collect the claimant and claim identifying information from the responses and analyze this information so it can separate them into responsive categories, such as a claim filed category and a no claim filed category. Preferably, the responsive categories will include a third party funds received category, a third party claim filed category and a no claim filed category to better segregate the responses. Where third party funds have been received or a claim filed, the carrier then collects third party claim information from the response and utilizes the identifying information and the third party claim information to identify a source of available reserve funds. In doing this, the carrier should compare the information received from the claimant to its records to determine if the claimant previously provided any of the third party claim information it has provided in his or her responses to the interrogatories. Depending on the carrier's business goals and objectives, the carrier can then apply the third party claim information to reduce the carrier's reserve fund requirement after obtaining a credit against future payments, reduce or stop payments to the claimant, enter into a stipulated lien agreement between the carrier and the claimant, seek subrogation recovery and/or evaluate the performance of one or more employees of the carrier. To simplify the step of collecting information from the responses, the carrier can utilize a case file cover sheet, preferably computer input based, to collect the identifying information and the third party claim information.

Accordingly, the primary objective of the present invention is to provide a method and system of identifying undetected third party settlements, claims and available reserve and/or subrogation funds for workers' compensation carriers that provides the advantages discussed above and overcomes the disadvantages associated with the present methods and systems of identifying such available funds.

It is an important objective of the present invention to provide a method and system particularly configured for use by workers' compensation carriers that is adaptable for incorporation into a computerized tracking system to assist the carrier with identifying available reserve, subrogation funds and funds to provide the basis of credits against future payments.

It is also an important objective of the present invention to provide a method and system of identifying available reserve and subrogation funds that is effective at identifying injured workers having likely subrogation issues and collecting information from the claims files of workers or their legal counsel relevant to such issues.

It is also an important objective of the present invention to provide a method and system of identifying available reserve funds that is relatively simple and cost effective to implement on a wide-scale approach.

It is also an important objective of the present invention to provide a method and system of identifying available reserve and subrogation funds that utilizes interrogatories and/or the subsequent claims reporting comparison approach to collect information regarding claims of one or more categories.

It is also an important objective of the present invention to provide a method and system of identifying previously unreported third party settlements and pending third party claims made by workers, claiming workers' compensation benefits, so carriers will have a relatively simple and cost effective way to effectively assert and collect subrogation funds without the need for costly litigation.

The above and other objectives of the present invention will be explained in greater detail by reference to the attached figures and the description of the preferred embodiments which follow. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a flow chart showing the steps involved in the method and system of the present invention;

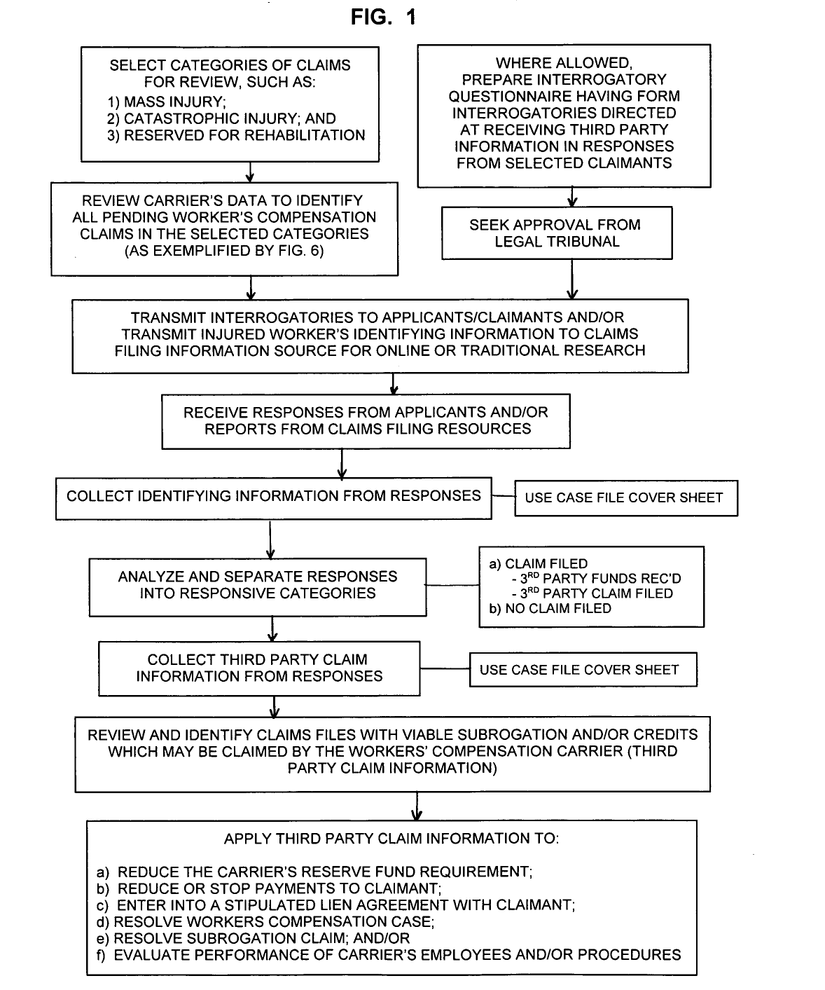

FIG. 2 is the first part of a sample form interrogatory set useful with the method and system of the present invention to obtain information from an injured worker and/or his or her attorney;

FIG. 3 is the continuation of the sample written interrogatory form of FIG. 2 useful with the method and system of the present invention to obtain information from an injured worker and/or his or her attorney;

FIG. 4 is a sample case file cover sheet useful with the method and system of the present invention to collect information from the responses received from the interrogatories of FIGS. 2 and 3 or from the subsequent claims reporting comparison approach;

FIG. 5 is a form letter useful with the method and system of the present invention to inform an injured worker and/or his or her attorney of the information determined from the interrogatory of FIGS. 2 and 3 or from the subsequent claims reporting comparison approach that is designed to elicit initial contact early on between the carrier and the claimant or the claimant's attorney;

FIG. 6 is form for listing some of the basic information required for the method and system of the present invention from which the categories for high yield claim files containing third party settlement and ongoing claims can be extrapolated; and

FIG. 7 is an example of a form memorandum that can be utilized with the method and system of the present invention to obtain information from the carrier's claim adjusters or examiners that cannot be found in the carrier's computer database.

### DETAILED DESCRIPTION OF THE PREFERRED EMBODIMENTS

With reference to the preferred embodiments of the present invention set forth below, the enclosed description and drawings are merely illustrative of preferred embodiments and represent several different ways of accomplishing the objectives of the present invention. Although specific components, materials, configurations and uses of the present invention are illustrated and set forth in this disclosure, it should be understood that a number of variations to the invention described herein and in the accompanying figures can be made without changing the scope and function of the invention set forth herein.

A. Definitions Utilized in the Present Invention

In the preferred embodiment of the method and system of the present invention, various terms that are utilized herein are defined below:

1. Carrier: Means any insurance company that provides state workers' compensation insurance coverage for premiums charged to or assessed against private or governmental entity insureds pursuant to the law of any state or government of the United States, the employers insured by such companies, including employers allowed to be permissively self-insured, whether it is a nonprofit or for profit enterprise, inclusive of its outside and contract adjusting service providers and inclusive of governmentally established insurers of last resort, whether or not the entity or is administrators or liquidators are still maintaining reserved funds for paying benefits due to claimants and/or where it is currently under the control of its state department of insurance, or other state or federal regulatory agency or in the process of conservation and/or liquidation or operating pursuant to the protection of Federal Bankruptcy Law, whether it be a debtor in possession or a conservator, whether or not the trustee or other entity is administering its reserved funds. Also, included in the definition of “Carrier” is any workers' compensation company established to provide such coverage to private sector or governmental entity insureds mandated by federal law (examples include Longshore and Harbor Workers' Compensation Act and the Federal Employee Compensation Act) where its scheme of providing workers' compensation insurance provides for or allows for its administration or fulfillment to be provided by private, governmental, nonprofit or for profit insurance companies, entities or administrators whether or not it is required to maintain reserved funds to cover benefit claims made. The term “Carrier” also applies to all reinsures, excess insurers, umbrella insurance providers, post occurrence insurance provider(s), speculators and specialty companies who provide such services to carriers and those who by process or operation of law or contract become responsible to manage the carrier's financial affairs (as an example, the State Insurance Guarantee Associations and agencies which govern or regulate the carrier in its respective jurisdiction) whether such providers are private sector, governmental or quasi-governmental entities.

2. Claimant or Applicant: These terms include an employee or employees who claim to have been injured in the course and scope of their employment for an insured employer of the carrier, who have submitted a claim for benefits to the carrier, a spouse or dependent(s) of a deceased employee who claims benefits due to an employee's death caused by a fatal injury inflicted while the deceased employee was in the course and scope of their employment for an insured employer of the carrier, who have submitted a claim(s) for benefits to the carrier, or any individual (including their legal representatives and guardians) or governmental entity claiming the return of benefits paid due to subrogation rights, priority of payment obligation (such as medicare), required by statutory, case law, contract or other legal process. This term is reflective of a claimant who is male or female, adult or child dependents of an injured or deceased employee of the carrier's insured employee. In circumstances where action is directed to or required from the claimant, such as transmitting an interrogatory questionnaire to a claimant, this term also includes the claimant's attorney (i.e., the applicant's workers compensation attorney, third party or other attorneys assisting in the prosecution of the applicant's workers compensation or related third party claims), whom the carrier is required to use as an intermediary for such action.

3. Catastrophic Claim(s), Claim Files and Injuries: Means all pending workers' compensation claims (a) reserved at $100,000.00 or above; (b) where two or more of the insured's employees have been injured in a single work related event and at least one individual of the injured employees has a claim file reserved at $100,000 or above, including all other claim files pending against the carrier in this injured group; or (c) where the claimant has been found to be 100% disabled due to injuries received, in whole or part, in an industrial accident or event, whether by the carrier's own estimation, other medical determination or by legal process. Also included in this definition are all similarly defined claims where the underlying workers' compensation claim has been resolved whether the claim file remains active, inactive, open or closed.

4. Mass Injury Claim(s), Claim Files and Injuries: Means all pending workers' compensation claims where, regardless of the monitory risk presented to the carrier by any one claim, 25 or more individual employees have been reported with similar injuries (example: inhalation injury to lungs, similar nervous system injury, similar injuries to the eyes, similar injury to specific organs, renal system, neural injuries effecting cognition) to the carrier within one twelve month period by the same insured or 100 or more employees reported injured to the carrier by separate insureds within one twelve month period, where the injuries reported are due to the same event, accident, exposure to the same toxic or hazardous substance(s), whether organic or inorganic (such as asbestos, silica, lead, benzene, industrial chemical, animal products, viruses, molds in the ventilation system of buildings), repetitive task procedures (such as carpal tunnel syndrome or other repetitive task injuries), injuries caused by any single large scale accident or event such as a building collapse on a construction sight where the reported injuries involve use by the injured employees of the same or same type of mechanical, electronic or hydraulic device(s), system(s) or equipment (such as scaffolding equipment, ladder(s), sand blasting equipment, pneumatic drills, welding equipment, respirators, and related protective devices), or as a result of any activity generally considered to be an ultra hazardous activity (activities where injuries are anticipated regardless of the how much care is taken to prevent them) such as explosive blasting, digging of tunnels, handling of radioactive substances, firefighting, or other types of emergency response or rescue tasks. Also included in this definition are all similarly defined claims where the underlying workers' compensation claim has been resolved whether the claim file remains active, inactive, open or closed.

5. Reserved for rehabilitation claims: Means all pending workers' compensation claims where, regardless of the reserve amount, the claimant or applicant is sufficiently injured that he or she will never be able to work at his or her previous job again. These claims are included as a major category of highly suspect files because they typically have significant wage loss issues, which also make these types of cases particularly appealing to plaintiff attorneys. Reserves for rehabilitation are those reserves where the workers compensation carrier has made a determination, at some time in the claims handling process, that a given claimant or applicant will not be able to return to his or her prior job and will likely require vocational rehabilitation in order to gain a place of employment to enable his or her return to the work arena or workforce.

6. Pending workers' compensation claims: This term includes each underlying workers' compensation claim that is unresolved, as well as, those that have been resolved or closed due a settlement between the carrier and claimant or by administrative or judicial law processes. Though the underlying workers' compensation claim is resolved, it is still pending for the purpose of this methodology, as long as the carrier has a viable third party or direct action claim to recover all or a portion of the benefits it has in the past or may in the future be required to pay a claimant as workers' compensation benefits, against a third party defendant(s), the claimant or the claimant's attorney(s), on any theories of liability cognizable in any administrative tribunal, state, or federal court where the carrier, has both standing and jurisdiction to sue the defendant(s) named in its complaint, pleading or initial moving paper. The type of legal actions referenced in this definition are not limited to traditional subrogation remedies, but while including them, anticipates a broader assertion of legal rights by the carrier. They include but are not limited to seeking redress for the negligent and/or intentional failure by the claimant to comply with statutory duties owed to the carrier, redress against attorneys who may have induced claimants not to comply with their statutory duties owed the carrier, negligence, fraud, civil conspiracy by others which have denied the carrier its benefit to due process of law, RICO claims, imposition of constructive trusts, and other more proactive causes of action which seek a broader scope of remedies, including the carrier's attorneys fees required to prosecute such actions, by which the carrier may seek to recover more than the mere return of the benefits paid to or on behalf of the claimant by the carrier.

7. Settlement, Court resolution, Settlements in or out of Court: These terms all refer to resolution(s) of the claimant's third party claim related to the same event from which his claim for workers' compensation arose. It includes settlements reached before or after the filing of a civil court lawsuit and awards which result from a jury verdict, a judge sitting as the trier of fact, mediation, arbitration or any proceeding up to and including a final appeal of the third party litigation, or thereafter.

8. Stipulated Lien Agreement: This term means an agreement entered into between the carrier and claimant, generally negotiated with the claimant's third party attorney and a representative of the carrier empowered with authority to negotiate such agreements. These agreements will generally best serve both the carrier's and injured worker's interests if entered into as soon as possible after the worker's industrial accident and after third party counsel has been retained. These written agreements fix in advance of a resolution of the third party case the percentage of the amount, or exact amount, the carrier will retain as its share of the funds realized when, and if, the related third party claim results in a financial recovery in the carrier's and worker's favor. Such agreements generally set the percentage of the third party recovery to be paid to the injured claimant and the carrier, and each party's respective duty to pay costs and attorney fees. For these agreements to be considered enforceable by the law of most jurisdictions they must first be presented to the administrative law agency or judicial authority or both to be ruled upon as a fair compromise between the worker and the carrier by the agency or authority overseeing the administration of workers' compensation system and/or judicial resolution of them.

9. Workers' compensation Appeals Board or WCAB: As used in this application WCAB is synonymous with any and all state or federal administrative agencies or tribunals, which regulate and provide administrative law or judicial tribunal review as tribunals of first recourse or initial review to determine disputes between claimants and carriers, has initial jurisdiction to rule upon such issues as the claimants entitlement to benefits and the amount(s) thereof, the employers right to take future credit as a result of third party settlements and the amount thereof, and all other issues which must be decided when disputed or approved for fairness, all agreed to issues and agreements between claimants, carriers and their legal representatives, such as approval of claimant attorney fees, etc. or the reasonableness of a third party attorney's fees claimed by him for the services he or his firm rendered in providing legal services which created the fund from which a carrier obtained subrogation benefits in the appropriate case.

10. Interrogatories or Questionnaires: These terms are used to refer to standard or typical interrogatories and questionnaires, including but not limited to written deposition questions or the like.

B. Stage One—Identifying Categorized Claims

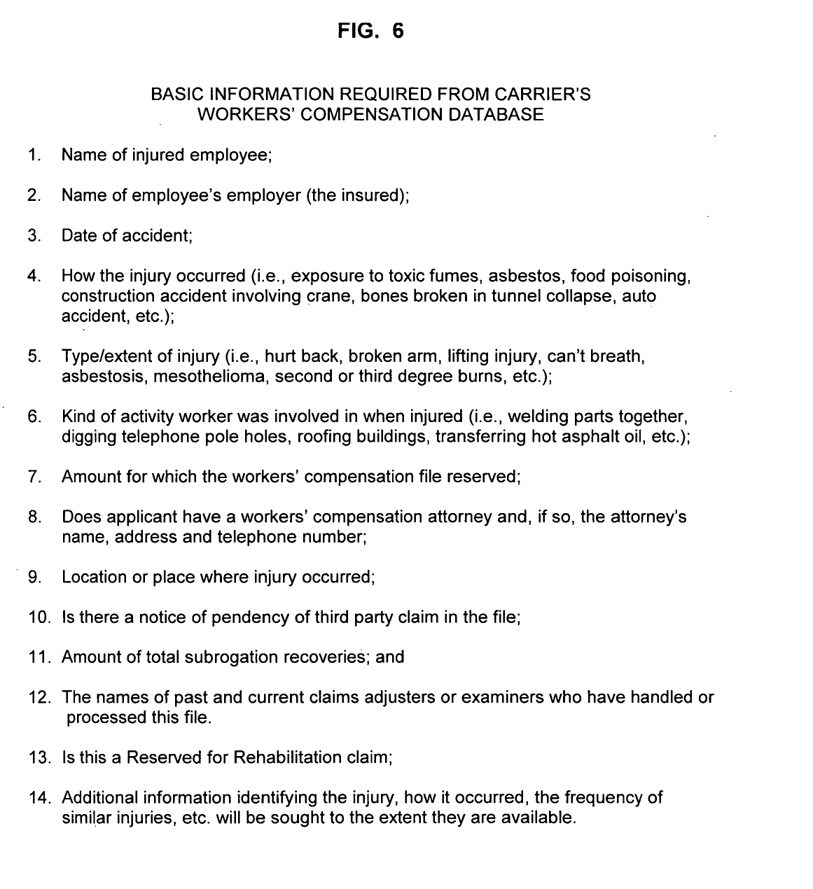

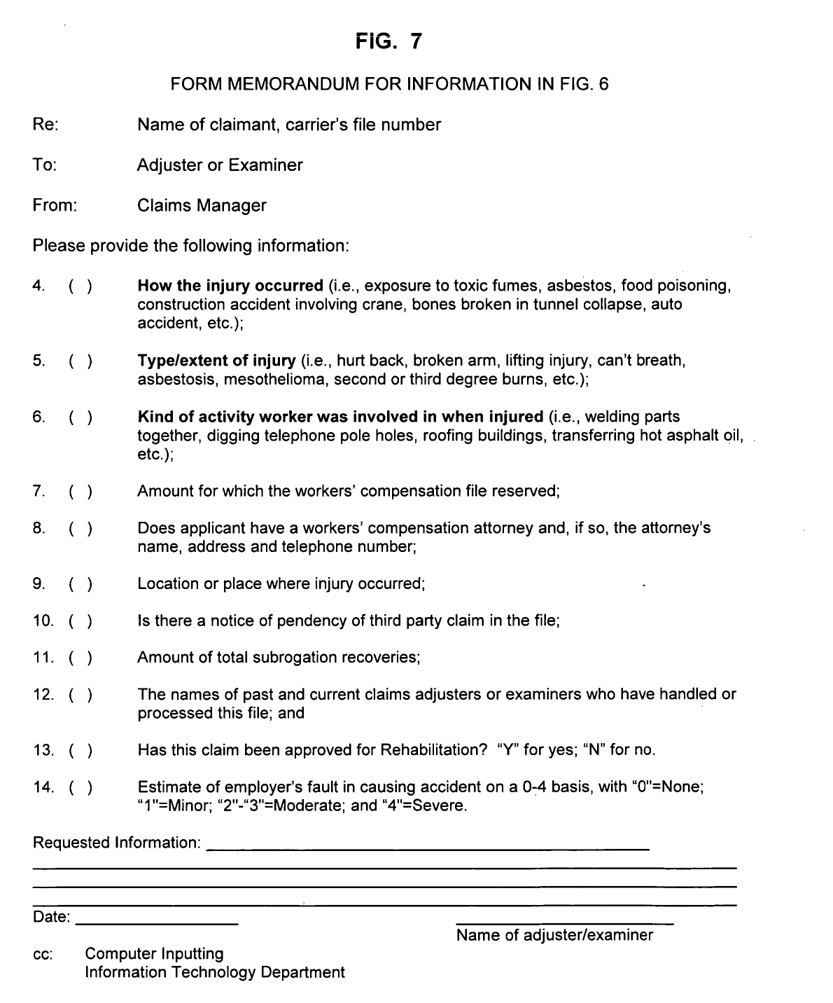

The first step in the method and system of the present invention is to select one or more categories of workers' compensation claims, such as mass injury claims (i.e., asbestos claims and the like), catastrophic injury claims (i.e., where an individual injured worker is determined to be 100% disabled) and reserved for rehabilitation claims, to review as a possible high probability source of available reserve and subrogation funds and then identify a plurality of pending workers' compensation claims the carrier has in the selected categories. Each of the identified workers' compensation claims will have a claimant, who may be the injured worker or a related party (such as a relative or other kin) associated with the claimant. The carrier can obtain the identity of these claims by reviewing its workers' compensation data, such as by searching its presently available computer records. FIG. 6 sets forth an example of the basic information required from the carrier's workers' compensation computer database. Most carriers will have much or all of this information readily available in its database system. A computer program can be and has been prepared to extract the information for FIG. 6 from the database specifically to facilitate the present invention (hereinafter referred to as the facilitation software program). If the carrier's database does not include the required information, a form memorandum, such as that shown in FIG. 7 (which is configured to have paragraph numbers that correspond to FIG. 6), can be utilized to obtain the information from the carrier's claim adjusters or examiners who are handling these claim files. The person operating this methodology can check off the information he or she needs from the adjuster's or examiner's returned memorandum and enter it into the facilitation software program. The memorandum of FIG. 7 also includes a “cc” designation to forward a copy of the information obtained from the adjuster/examiner to the carrier's computer technology department, or equivalent, so the information can be inputted into the database for future reference.

In addition to cases usually thought of as mass injury such as asbestos related injury claims, there are a variety of other types of injuries that can be considered mass injury, including injury by exposure to welding fumes, various work place dusts, silica, cotton, carbon, molten metal fumes, lead, chemicals, molds, sick building exposures, loud noise causing hearing loss, exposure to sick livestock, repetitive task injuries and etc. Every carrier should be aware of mass injury claims peculiar or unique to its own coverage sold or insured's profiles (portfolio). For instance, a carrier which insures an aircraft manufacturer where 300 employees have reported a range of minor to serious injuries thought to be caused by a special glue designed to allow aircraft to have seamless welds obviating rivets, must realize this group of claimants should be added to the list of mass injury cases for the purpose of more fully and efficiently applying this methodology. Mass injuries, which pose a risk of harm, injuries, disease or death in the future or pose a need for future medical monitoring are likely to generate related third party litigation. For the reasons stated below, such files are a good place to look for a significant number of unreported settlements. Claims supervisors should be asked to help identify mass injury groups that are known to them, as well as the claims being supervised by them which are catastrophic, because this unique commonality of claims information may not have been reported or entered into the carrier's computer. The claims supervisors can also help by providing a list of claimants who may not be 100% disabled, but who are severely disabled and likely to be involved in third party litigation at some point in the future. A carrier wishing to cast an even larger net, may do so by including a list of all known subrogation cases for which third party settlements or third party case resolutions have or have not been reported for a specific period of time following their initiation, where not all third party defendants have settled or have been judicially resolved out of the related third party case(s). The net can be made more encompassing by lowering the bar on the definition of catastrophic to include those claimants who are less than 100% disabled or whose cases pose less than $100,000 in risk to the carrier. If desired, this can be done in phased stages until the actual results seen in Stage Two become too insignificant in the carrier's judgment to pursue further.

The reason mass injury and catastrophic injury claims are among the two most productive file categories from which to discover a large number of unreported third party settlements is because they tend to be multi-defendant claims when litigated as third party cases. For example, it is not uncommon at all for asbestos third party claims (mass injury claims) to name in excess of thirty defendants. There are several reasons for this, including: (1) most asbestos victims are exposed to numerous manufacturers' brands of asbestos, marketed by a number of different distributors, all of which may be liable at law; and (2) mass tort personal injury cases tend to require a large amount of insurance coverage or assets to resolve them by the very nature of there being hundreds of thousands or even millions of people who have been harmed by exposure to a common substance(s) like asbestos. Even in a joint and several litigation jurisdiction where the case need be proven against only one of several defendants and that defendant is liable in full for all of the plaintiff's damages, it is unlikely that one or even ten defendants will have adequate funds, assets or insurance coverage to resolve a vast number of similar claims. Multiple defendants are named to best ensure that viable third party asbestos claimants will in fact have their court verdicts paid and the defendants sued as a whole will be able to fund settlements for the longest period of time.

Likewise, plaintiffs personal injury firms or practices, especially those which regularly represent mass injury claims and catastrophically injured clients, handle cases that can be quite expensive and tend to take longer than the average small or medium size case to resolve. For instance, a major case may involve two hundred or more depositions instead of the ten or less that is typical in many cases. The time from report of injury to jury trial can be five years or more and it could take ten or more years to resolve if an appeal is taken following a successful trial. Even after a successful appeal in the plaintiff's favor, part of the case may have to be retried. Likewise, asbestos cases as a body of litigation, due to appeals and defendant bankruptcy filings, provides an example where many cases filed twenty-five years ago are still pending in trial level courts, the litigation expenses and costs still borne by the plaintiff attorneys and law firms retained a quarter of a century ago. As a result, these types of cases place a significant financial burden on the plaintiff's attorney or law firms. For all of these reasons, as well as others, it can be expected that in both category of claims (mass and catastrophic injury) there will be several settlements in the average multi-defendant case over time, years before the case is ever tried, if it ever is tried, or otherwise finally resolved. The funds from settling with certain parties are then utilized to fund the continued litigation against the remaining third party defendants. In fact, most of these cases are settled with an eye toward keeping at least one viable mid to major liability defendant in the case until trial so that any such case that goes to trial will be cost effective.

The mass injury and catastrophic injury categories of workers' compensation claims generally produce multi-defendant third party cases, where partial settlements are frequently made, but not reported to the carrier until late in the course of the third party litigation, if at all. A major reason these settlements or resolutions are reported late in the litigation process by plaintiff counsel, if at all, is because by then the carrier has lost most of its subrogation recovery leverage. The injured worker is free to make a full frontal attack alleging employer contributory negligence or comparative fault now that doing so will not diminish the value of the injured worker's third party claim. Although they may not be multi-defendant cases, reserved for rehabilitation determinations are often not made by carriers until late in the handling or adjusting of workers' compensation claims. Their value as plaintiffs cases are generally not recognized for a year or more after the filing with the carrier of the First Report of Injury.

Because the carriers have not yet discovered a cost effective methodology to police the non-disclosure of third party resolutions, there are likely many millions of dollars in the reserve accounts of every carrier in the nation that continue needlessly to reside there for many years and significant subrogation recovery funds and assertable credits available to the carrier. The method and system of the present invention provides a cost effective, time efficient approach that will enable the discovery of these previously undisclosed settlement/court resolution funds. This will provide the carrier an opportunity to resolve many related workers' compensation and subrogation claims in their totality, on terms beneficial to it, from an improved bargaining posture, once future credits are obtained and it has the ability to stop or not stop the payment of workers' compensation benefits to claimants whose third party claims are not yet resolved in full.

C. Stage Two—Obtaining Information by Interrogatories and/or the Subsequent Claims Reporting Comparison Approach

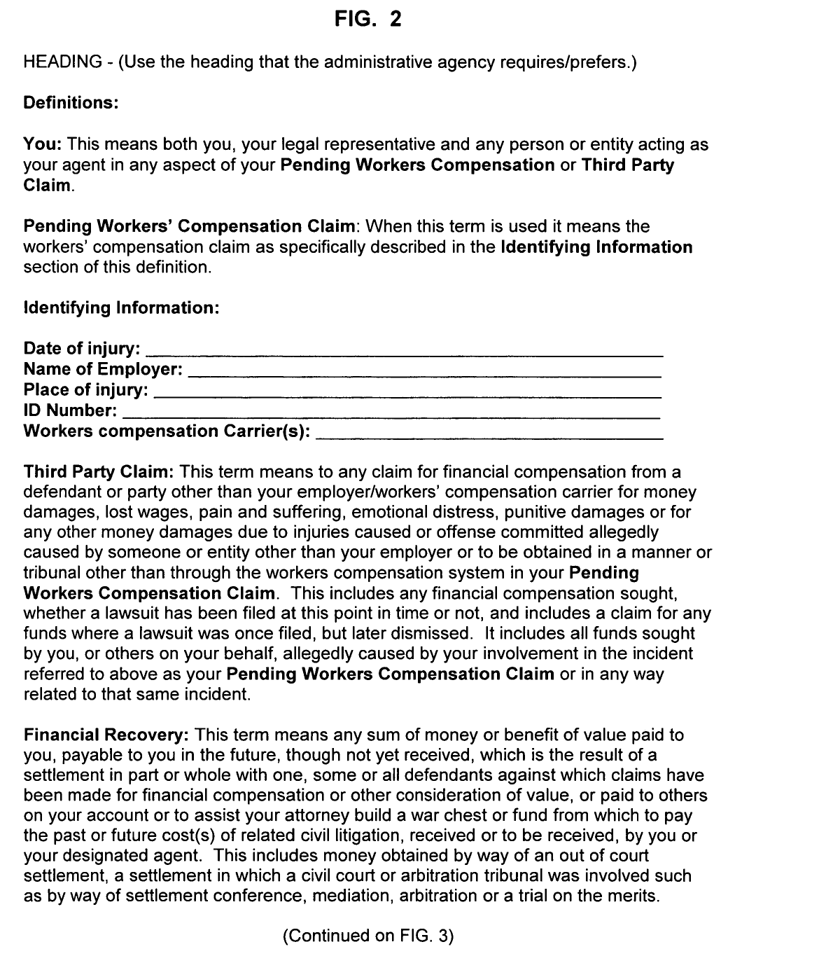

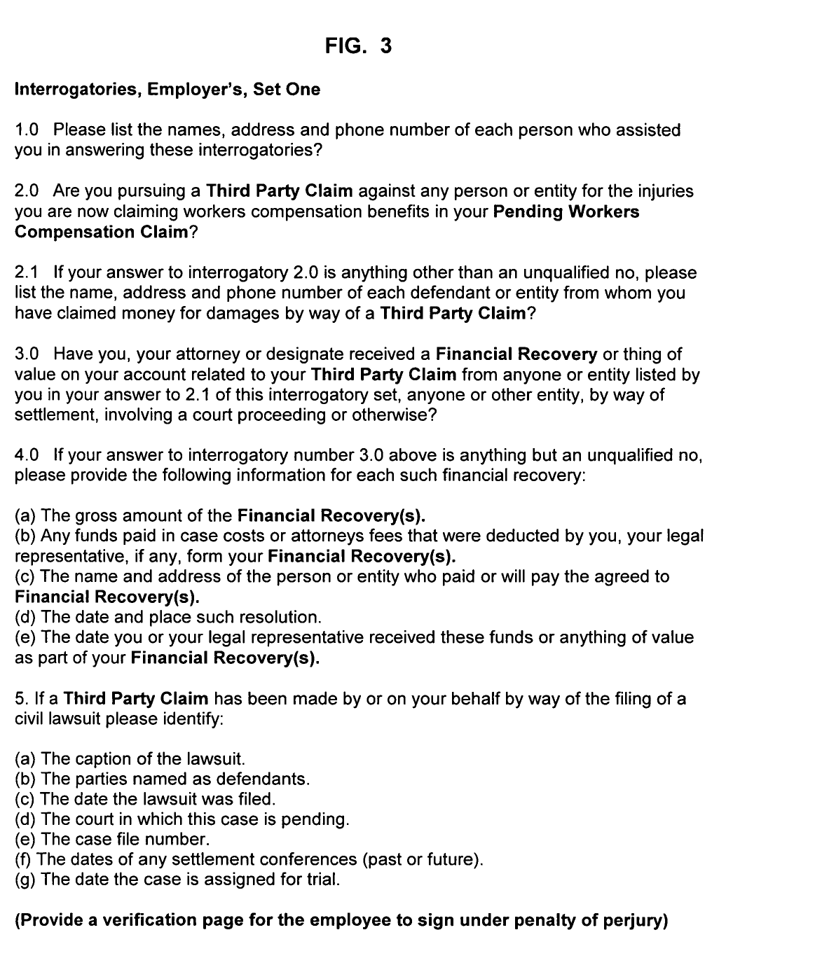

With the lists that have been prepared baring the names of thousands of claimants from the selected categories (i.e., mass injury, catastrophic injury and reserved for rehabilitation), the carrier should prepare an interrogatory questionnaire form having a generic set of interrogatories that are applicable to the categories (as known to those skilled in the art of litigating such categories of tort case, the interrogatory questionnaire can be prepared prior to or during Stage One) or initiate the subsequent claims comparison approach to obtain information for later review and analysis. An example of such an interrogatory questionnaire is set forth in FIGS. 2 and 3 (with FIG. 3 being a continuation of FIG. 2). The interrogatory questionnaire should be configured to obtain responses from the claimant with regard to any pending or resolved third party claims he or she may have or have had. In many states, a workers' compensation carrier whose insured is a party to a workers' compensation case can submit written interrogatories to the claimant (i.e., the injured worker seeking benefits) once the claim has been assigned a case number by the administrative law authority or court with jurisdiction over the claim, generally after an application for adjudication of the administrative claim has been filed by the injured worker, his or her family, or his/her/their attorney. This assignment usually takes place soon after a report of injury is filed with the administrative agency and then received by the carrier. In many states, discovery by way of written interrogatory is a matter of statutory right. The only restrictions traditionally found are those which restrict the abuse of such discovery, such as sending out too many sets of interrogatories too frequently, voluminous numbers of questions, and the like. As known to those skilled in the art of worker compensation and tort litigation, the carrier must transmit any interrogatories directed at the claimant for his or her responses through the claimant's attorney if the claimant has hired an attorney and the carrier has knowledge of the attorney.

Presently, the right to use written interrogatories is rarely exercised in the workers' compensation industry because the preferred way to obtain information from a claimant is by way of deposition. The workers' compensation defense bar prefers this approach because it can ask a very wide variety of questions dealing with a large number of issues. However, the claimant's attorney is often awarded as much as $250 or more an hour to attend these depositions to protect the client. Outside defense attorneys representing the carrier also earn substantial fees. Insurance attorneys who work for the carrier also present significant transactional costs. As discussed above, depositions are neither a cost effective, timely nor expeditious method to obtain the narrow scope of information required to detect files containing non-disclosed settlements. Even if the carrier could set 10,000 depositions back to back, and were allowed to do so, the effect of so doing would bring the movement of business before the state administrative agency, such as the WCAB, to a dead halt and there would be a shortage of workers' compensation attorneys available to attend to the other important business which must move forward within the workers' compensation system. In those few jurisdictions where special leave of the workers' compensation agency or a court is required on motion to obtain leave to send out even this short set of interrogatories, it is anticipated that such leave should be easily obtained. Good cause exists for the carrier to obtain by legal process that information to which it is entitled as a matter of law. It may be wise, even where not required, for the carrier to prepare a master form of interrogatories similar to that set forth in FIGS. 2 and 3 and obtain advance approval of the form interrogatory set from the WCAB, a court of competent jurisdiction or other legal tribunal, so that prior to transmitting them to the claimants and their counsel on a statewide basis the carrier will have the peace of mind of knowing a pre-approved single generic set of interrogatories, narrowly drafted to serve its purpose, will be answerable without objection, and returnable in a short period of time. Pre-approval should not be a difficult matter for a one or two page generic set consisting of only six or so questions, all relating to the same narrow issue. The purpose of the pre-approval would be to save the WCAB or other legal tribunal the task of hearing challenges to them on frivolous grounds, and further reduce the transactional costs to the carrier, while expediting the return of interrogatory answers.

The example interrogatories set forth in FIGS. 2 and 3 are an exemplar of a suggested set of interrogatories to accomplish this purpose. Naturally, this exact set of questions is not required. The carrier, employer and their counsel can devise a set of interrogatories they believe will obtain the desired responses to bring about the best results in their various jurisdictions. Seeking the necessary information by written interrogatories will produce answers, under penalty of perjury, directed specifically to discovering the heretofore undisclosed third party settlement or court resolutions (and other related details). Typically, the state civil procedure laws allow the carrier to have its responses within a set number of days after mailing them to the claimant's counsel or claimant (i.e., 35 days pursuant to California state law for written interrogatories served by mail). Once the carrier receives the answers to the interrogatories, it can move on to Stage Three of the methodology.

As set forth above, the subsequent claims reporting comparison approach will produce information or other results similar to that described above with the use of interrogatories. In fact, in many jurisdictions it may be more expeditious and less expensive manner to gather the same basic information otherwise provided by interrogatories. In other jurisdictions, the state law may not allow or enforce the use of interrogatories in administrative proceedings such as workers compensation adjudications. In those jurisdictions, the carriers will utilize the subsequent claims reporting comparison approach to compare the files that have been identified as catastrophic claims, mass injury claims and/or reserved for rehabilitation claims to information obtained from the Insurance Index Bureau, ISO Tech, Marine Index Bureau and/or other online and off-line claims filing information sources. These sources can and should include traditional court service companies and other services that can identify subsequent third party personal injury and wrongful death lawsuits, including medical and legal malpractice claims, alleging facts with sufficient particularity to identify them as being related to the underlying industrial accident. Naturally, the subsequent claims reporting comparison approach can be utilized in conjunction with interrogatories in those states that allow interrogatories in workers compensation proceedings.

It must be noted that the workers' compensation industry is moving toward having all its claims file data digitally entered or optically scanned into its computer systems by way of optical character recognition software (OCR) in an effort to run what is now referred to as paperless offices. This means that more inclusive data will be available by utilization of only the Subsequent Claims Reporting Approach allowing this methodology and invention to gather all of its required information on a completely computerized basis. However, until that optimal time is reached and becomes a reality for a given workers compensation carrier and its Claims Report Provider(s)', especially in jurisdictions where neither interrogatories nor written depositions may be utilized in the carrier's workers' compensation system jurisdiction, some of the data required for a full utilization and ideal performance of this methodology can be completed by the manual acquisition of data which is available but is not yet computer accessible at the present time. For example, this may include the identity of the third party attorney and that office's contact information, or information regarding the specific amount of a known third party recovery may not be presented among the Claims Report Provider(s)' data.

To complete this task so that the files will have the full amount of data to maximize the benefits of Step Three, more fully set out in the next section, an in-house or outside information acquisition team can be quickly be assembled and trained as required to make phone calls, send memos to claims personnel, mail form letters, and perform the minimal skill tasks required to obtain the full compliment of desired information. This staff need not be trained to the level of claims adjusters nor have legal training. This is a task most high school graduates or college students can quickly be trained to perform on a full or part time basis. Likewise, in jurisdictions where interrogatories are allowed in the workers' compensation system a similar group of semi-skilled workers can be utilized to sort out interrogatory answers into the desired groupings and enter that information onto computer readable sheets or cards which are then scanned into the software program designed to apply this methodology or in the alternative entered by skilled computer operators, whichever presents the most desirable combination of efficiency, economy and accuracy.

D. Stage Three—Analyzing the Interrogatory Responses and/or Information Gathered by the Subsequent Claims Comparison Approach

Major benefits to the carrier have been achieved by the use of this methodology when the answers to the interrogatories and/or information gathered by the subsequent claims reporting comparison approach referred to in the Stage Two above are received and reviewed. Whatever procedures the carrier takes to provide for the overall adequacy of its reserves must be controlled by its own good business sense, within the parameters of the law mandated by its own jurisdiction. The additional steps below, if followed, should be adapted with this in mind.

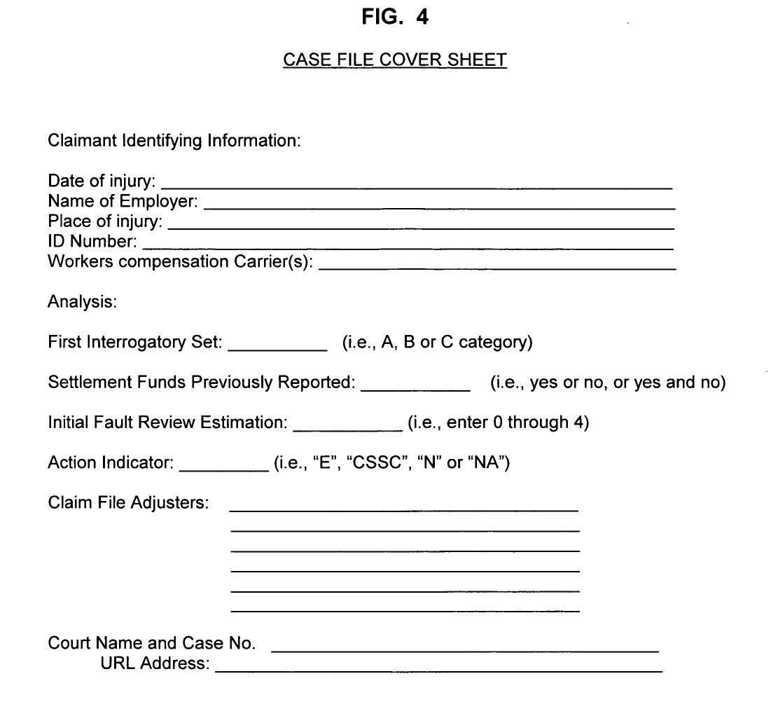

Regardless of the carrier's primary goal, a list of minimal information should be made on hard copy or computer generated and stored case file cover sheets for each claim that is reviewed. Certain identifying information should be entered for each claim reviewed on a case file cover sheet (an example of which is set forth as FIG. 4), such as the worker's name and workers' compensation carrier ID number. This identifying information comes directly off the carrier's computer database. Computer entry of the case file cover sheet is preferred because this will expedite use of the stored information and will be part of a computer database follow up system to detect future third party case resolutions. Most of the unreported settlements or court resolutions will have been effectively uncovered by the responses received from the interrogatory mailings and/or the from the subsequent claims reporting comparison method after those responses are received. The following procedural suggestions are meant to be flexible and modified by the carrier where it thinks best. This case specific database can be modified, updated, and adjusted to fit changing goals set by the carrier and to monitor the progress of this methodology in meeting the carrier's goals. It can be an important part of a system which provides an ongoing status report assisting in the continuing improvement of the methodology and, over time, allowing it to better fit the needs peculiar to each carrier. It can also identify where the carrier can improve its procedures directed at the early detection of potential third party involvement from the First Reports.

1. Where Reserve Reduction and Increasing Free Cash at Hand is the Primary Goal:

The carrier analyzes the responses from the interrogatory questionnaires and/or from the subsequent claims reporting comparison approach and separates the responses into two or more responsive categories based on the carrier's desired action. For instance, the carrier can separate all incoming responses into three responsive categories, referred to herein as Category A, Category B and Category C. In this example, Category A responses are those which disclose the receipt of third-party settlement or case resolution funds, Category B responses are those which disclose that a claim or complaint has been filed but reveals no third party funds received, and Category C responses are those which disclose neither the filing of a third party lawsuit or claim, nor the receipt of related funds. On the case file cover sheet list either an A, B, or C after the caption “First Interrogatory Set” on each claimant's case review cover sheet (all subsequent captions or recommended entries are to this cover sheet).

Focusing on the Category A responses first, the carrier gathers all the related workers' compensation claim files which correspond to each claimant, manually or by computer, and then determines if the settlement or court resolution information reported by the interrogatory and/or the subsequent claims reporting comparison approach responses were previously reported to the carrier and separates those responses into two or more categories depending on whether the response was previously reported to the carrier. The answer “yes” or “no” is entered on the cover sheet next to the caption “Settlement Funds Previously Reported:” (the answer “yes and no” is where one settlement was reported and another not). The carrier then makes a realistic evaluation, based on the information in the file, whether or not an allegation can be made in good faith by the claimant's attorney that the employer was at fault in causing the workers injuries. At the caption “Initial Fault Review Estimation:”, the carrier enters an evaluation number, such as 0 to 4, with 4 indicating there are no facts identified which appear to evidence employer negligence as a cause of the injury. Next a “0.0 to 0.4” number is given evaluating the third party liability. For example, a “4.4” would indicate no employer fault and good third party liability. Then, after being provided with an evaluation number to serve as a guideline by the carrier's management, the carrier will determine whether this case meets and exceeds that number (i.e., 0.0 through 4.4) above which a credit will be sought and below which it will not. The carrier may wish to allow for a bit more subjective judgment by considering the size of the settlement reported or other factors. For instance, if the amount of the settlement clearly exceeds the amount of money owed by the carrier, example $10,000 in permanent disability still owed, no open medical and the injured worker's net settlement is for $100,000, the carrier can enter “E” to indicate adequate funds have been identified to extinguish the claim after the caption: “Action Indicator:”. Here the carrier will likely obtain the credit and seek to remove the committed reserve funds deposited for that claim and the aggregate of all similar claims. Where it is not quite so clear if the amount of the settlement(s) or funds resolution is adequate to negate the compensation claim the carrier can enter CSSC after “Action Indicator:” to indicate that it should seek a credit in the amount of the claimant's net recovery and a reserve reduction sought not to exceed the amount of the injured worker's net recovery or allowed credit, whichever is less, as a result of the settlement(s) reported in the interrogatory or from information obtained from subsequent claims reporting comparison approach responses. Where the settlement(s) is so small that it does not appear to warrant the time and costs of seeking a credit approval at the time the funds are identified, the carrier can so indicate by placing an “N” for “none at this time” after the caption “Action Indicator:”. The term “NA” should be entered after “Action Indicator:” to indicate this file presents a peculiar situation not appropriate to seek credit (i.e., worker in hospital about to die from work related injuries). In these situations, the carrier may do better to seek a credit at a later and perhaps more appropriate time, keeping in mind comparative fault and other issues. The recorded entries after “Action Indicator:” will then read “E”, “CSSC”, “N” or “NA”. The above suggested cover sheet data entry codes are merely suggested possible entry codes, the carrier may wish to use them or not, or greatly expand upon them. The principal consideration is that a computer (preferred) or manual system should be established so that the information discovered can be efficiently acted on in mass units. It Is up to the individual carrier to decide how mechanical or digital (i.e., accomplished by computer) it wishes to make the process. Generally, as known to those skilled in the art, the more the information is processed by computer the more expeditious the resolution. The more subjective and skilled the people making policy decisions, the less likely errors will be made. The carrier will determine its own balance between these two factors as a business judgment call.

The cover sheet should also list after the record entry or heading “Claim File Adjusters:” a sequential list of all claims supervisors, adjusters, subrogation department personnel, including attorneys. This should be done so the carrier can, in retrospect, review the procedures that have allowed these third party cases and the resulting undisclosed settlements and in court resolutions to go undetected until now. The idea here is to improve the carrier's initial screening process. The carrier must understand that no matter what it does some of these third party cases will always escape early detection. Its goal should be to tighten the sieve through which they are strained to detect as many as early as possible.

For cases in both categories “A” and “B” (where the third party defendants remain unsettled in open civil claims) files should have the claimant's responses to interrogatory 5 (d) and (e), or similar information from the subsequent claims reporting comparison approach, entered on the cover sheet, preferably configured as a computer data entry program, with the Internet dial up address of the identified civil court house, if similar on-line court information is available in the jurisdiction where the claimant plaintiffs third party case is pending, so that for each claimant listed the program will include, as an example, information such as the following:

Joe Doe, case number, Los Angeles Superior Ct, http://www.sftc.org/browser_pages/General%20Civil/Civil_General_information.htm.

This Internet address opens a free web site from which any California Superior Court civil action registrar can be reached and then opened by either case number or party names (such Internet sites are emerging in most jurisdictions). More and more states are making this service available without charge and there are also for charge web sites that provide this service for a reasonable fee. A software program should be designed to automatically dial-up or otherwise connect to the appropriate web site for each required court (some court systems also provide this service for all state or federal courts to be obtained from one URL address) then seek the appropriate register of actions page for the identified case, then word scan and check the documents listed in the courts registrar (register) of actions log for such word as: “settlement” and “C.C.P. Section 877”, California's good faith settlement approval statute, or the relevant jurisdiction's similar statute(s). This online screening for settlement indicia should continue as long as the workers' compensation case benefits remain unpaid and/or the subrogation issues are not yet resolved and the carrier's claims or methods of recovery remain viable (for example not yet time barred). When the computer program identifies a key word signifying settlement activity, the program should then report this to a designated individual or department at the carrier or an outside service provider by way of email reports. In those jurisdictions where no such automated facilities exist for the trial court where the third party cases are pending, the claimants and the third party attorneys should be contacted to seek the information sought by the interrogatory set exemplified in FIGS. 2 and 3. If the information is not provided freely, a second set of interrogatories should be sent out to those claimants and their attorneys to obtain the information or additional effort put into the subsequent claims reporting comparison approach.

If the claimant's counsel attempts to stonewall the carrier by pointing out the settlement amounts have been sealed, if in fact they have, the carrier should then determine whether a lien or complaint in intervention is required to give it appropriate standing as a party to the litigation. In some states, such as California, where a subrogation lien is filed and the issue of employer contributory negligence or comparative fault has been raised by affirmative defense to either the injured worker's complaint or its lien, the lien has no real value unless the issue is litigated and resolved to some extent in favor of the carrier/employer. Prior to sending out a second set of interrogatories or performing additional subsequent claims reporting comparison work, the carrier should file a complaint in intervention, so that its standing to be made aware of all settlements cannot seriously be disputed. If the claimant's counsel persists to secret the settlement or case resolution from the carrier, a formal motion from the vantage point of a party litigant to reveal the settlement amount and terms, in camera if necessary, should be pursued. This process can be expedited by well drafted form motions to compel requiring a minimum of manual effort. The motion should clearly state that no use of the information obtained will be made before the WCAB or appropriate adjudication state administrative agency for that jurisdiction except by requested in camera proceedings, so scheduled to conform with the court's ordered confidentiality. Where the carrier does not wish to invest in the cost of the necessary computer program to enable this follow up system, the same can be accomplished manually, but this likely will be more costly in the long run. This is a judgment call for the carrier's management.

Category C files did not provide adequate information to input for online follow up of a later-filed third party lawsuit. For this reason, periodic follow up (i.e., quarterly or yearly) interrogatories and/or additional subsequent claims reporting comparison approach are the only reliable methods of follow up screening for undisclosed third party resolutions, other than to ask the claimant's counsel the appropriate questions as propounded in the proposed interrogatories (i.e., FIGS. 2 and 3) or the claimant when his or her deposition is taken in either the workers' compensation or third party case or by informal letter or phone call to the claimant or claimant's attorney.

2. Where Reserve Reduction is not the Primary Goal:

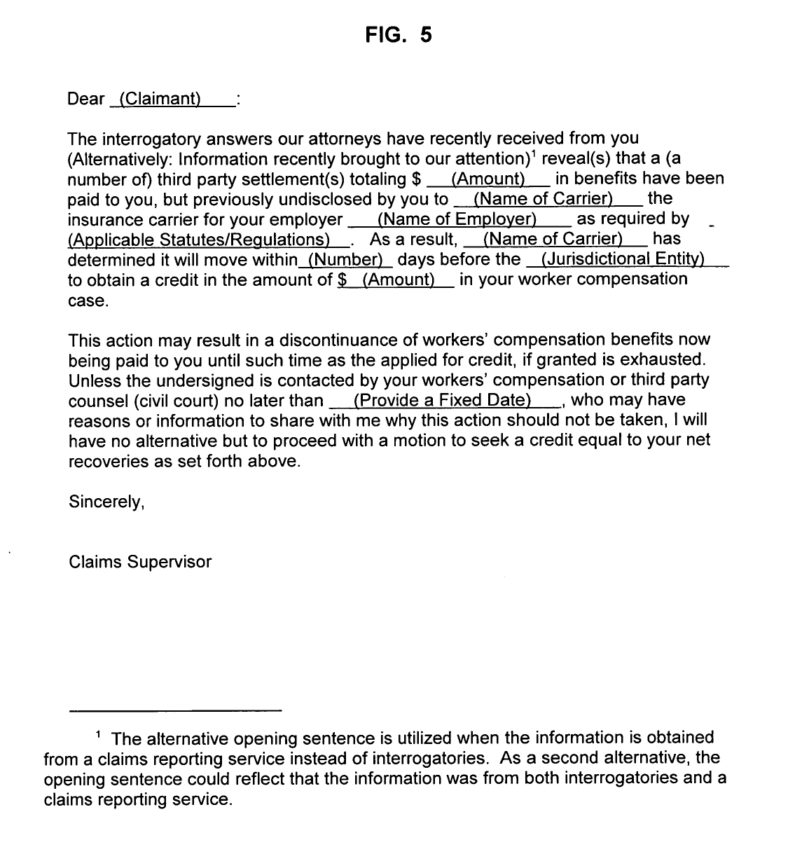

If the settlement amount does not seem sufficient to delay the payment of benefits for long, or for other reasons the carrier believes its best interests will be served by first seizing upon the rare opportunity presented by early discovery of undisclosed settlements to attempt to resolve the underlying workers' compensation and subrogation issues, on terms beneficial to the carrier, it may be best to send out a form letter similar to that shown in FIG. 5 as a professional courtesy to the claimant and his or her attorney(s). This type of letter can also serve as a subtle indication that the carrier is willing to listen to reason or have any of its potential misconceptions, entitling it to take a credit for the settlement, corrected. Although any such letter should, where allowed, be sent or copied to the claimant, his or her workers' compensation attorney and his or her third party attorney, it is likely the third party attorney who is the one most concerned and able to act with authority to negotiate with the carrier concerning the subrogation or overall case resolution issues. Certainly this professional courtesy should be welcomed. Also, this helps prevent the passage of time from preventing the communications to one attorney from reaching the other, the one with whom the carrier most wants to speak (a wise third party attorney may also recognize this as a potentially beneficial event). This should prove to be a good method to start introducing and educating the claimant's third party attorney about the subject and mutual benefits of stipulated lien agreements entered into early in the third party litigation process between the carrier and claimant. Selected files and/or all application for credit procedures, based on the newly discovered settlement funds, can be delayed at this point to allow an opportunity for such issues to be considered by both sides. One of the key benefits of this methodology is that the interrogatories and/or the Claims Reporting Comparison Approach, together with the follow-up letter, provide both the carrier and third party counsel a rare dignified method of making each other's acquaintance well prior to the conclusion of the third party case, of which the carrier may have otherwise been unaware. Perhaps the claimant's counsel has good reasons why the carrier should not seek a credit. Certainly the carrier would want to afford the claimant and his counsel the opportunity to bring this to its attention prior to the carrier making its motion for credit. Because these newly identified funds may have been unnecessarily tied up for years at this point, a few more weeks delay to allow such communication should not make that much difference.

It is a rare third party plaintiff's case which cannot benefit (i.e., increase its value) from some cooperation provided by the workers' compensation carrier. Once the third party attorney realizes that both he and his client, as well as the carrier, can benefit by entering into a stipulated lien agreement, it is not uncommon for the claimant and carrier to conceptualize themselves as on the same team, wanting to see a good outcome for the third party case. Once a stipulated lien agreement is entered into and approved by the WCAB, or other governmental agency or tribunal, both the worker and carrier will usually be represented by the injured worker's chosen counsel, with all potential conflicts of interest already waived in writing by both sides. This degree of cooperation in subrogation between potentially conflicted parties is anticipated and approved of by California's Labor Code and similar legislation in most jurisdictions.

Once a claimant and carrier enter into a stipulated lien agreement they will know exactly the amount each party will recover at differing financial levels of case resolution, in advance of that level being reached. If the third party case is lost there will be no subrogation benefits obtained. In either event most or all of the recognizable disputes between claimant and carrier are eliminated. Regardless of the outcome of the third party case, a stipulated lien agreement markedly reduces transactional costs for the carrier. Claims supervisor's time can be spent on cases where there are no subrogation components or where stipulated lien agreements could not be reached. The need for workers' compensation counsel to do battle and for carrier-retained subrogation counsel to be on the payroll traditionally drops to near zero in the average case. By itself, this results in substantial savings to the carrier.

Thousands of injured workers, who are mass injury victims, may be represented by a single attorney or law firm. Here the carrier has an opportunity to develop a pattern stipulated lien agreement, which after the master draft has been agreed to by both lead plaintiff counsel and the carrier, can be offered across the board to all of that attorney's or firm's similarly injured clients. The carrier's consent to the agreement can even be preconditioned on the acceptance by a given percentage of that attorney's or law firm's mass injury caseload, where such offers are not prohibited by law. This type of stipulated lien can be presented to a thousand or more clients at a single or series of client meetings were it is explained to them by their own counsel. If the offered agreements are accepted by both sides, hundreds or even thousands of subrogation claims can be resolved in little more time than would be expended similarly resolving the same issues related to a single claim, case or claimant. This brings a tremendous economy of scale to both sides. Even though a few third party cases may be lost at trial, the overall settlement experience of the group will likely benefit the carrier, since most claims are resolved by settlement. Most mass injury cases settle, the greatest effect of the trial experience in mass tort cases is to establish a set settlement value for the over-all caseload and the settlement amounts to be paid by specific defendants.

Since this methodology creates a valuable window of opportunity for both sides, which is likely to be fleeting if not acted upon quickly, it is strongly suggested that prior to sending out letters similar to that suggested in FIG. 5, the carrier should make sure it is prepared with the appropriate staff or outside specialty service providers (claims supervisors, attorneys, etc.) knowledgeable both in the various aspects of stipulated lien agreements, mass and catastrophic tort litigation from the plaintiffs prospective, properly trained and dedicated to the task of responding promptly to the anticipated positive interrogatory answers (those revealing prior undisclosed settlements). Discussions need to take place between the subrogation and claims factions of the team, so that negotiators have a general idea of their negotiation authority. Differences in claims management philosophies need to be discovered and resolved before the onslaught of opportunity comes knocking on the carrier's door. The carrier should make itself aware of what the claimant/third party attorneys need and to what extent it can facilitate those needs. Some of this will only come with experience. It is preferred that the lead negotiator(s) already have a good deal of experience from the plaintiffs perspective and be vested with the appropriate level of authority to have the negotiator taken seriously by the plaintiff third party counsel.

Great care should be invested in selecting lead negotiating counsel and claims staff. Freeing up potentially hundreds of millions of dollars in reserves and/or beneficially resolving many thousands of subrogation claims in record time on beneficial terms to the carrier deserves more than the part time attention of a few dozen already overworked individuals. This is especially true when it comes to the time demands of larger mass and catastrophic injury cases. Having a qualified individual(s) to perform this task will not only reap benefits for the carrier directly, but indirectly by providing a training source for those who will later do the same job. Because this process primarily sounds in subrogation it should be handled as a plaintiff attorney's task, by a plaintiff attorney or firm familiar with subrogation issues and law of the jurisdiction. The carrier should consider retaining plaintiff attorneys who will be received as peers by the senior partner(s) of the plaintiff firms who traditionally make the key decisions on such major complex litigation issues. This will also help eliminate the traditional bias and destructive advocacy which exists between the plaintiffs' counsel, defense bar and insurance industry and, as a result, make negotiations less of an uphill effort than is currently the situation.

Because this methodology is capable of creating a very serious, time sensitive, window of opportunity for both the carrier, the third party firm and their client(s), it should be seen for what it is and prepared for accordingly. The recommended goal for the carrier is to take full advantage of the opportunity to negotiate and obtain favorable en masse resolutions of subrogation related claims. All appropriate preparations should be made or at least considered, including finding an experienced, knowledgeable person to oversee the carrier's interests. For instance, the carrier can seek out individuals for this task who are personally known to the small inner circle of plaintiff attorneys who generally represent major personal injury litigation in their respective jurisdictions, so that contact can be made by phone fairly informally. It should be kept in mind that this methodology enables and provides a roadmap to resolution, not confrontation or advocacy in the traditional sense.

(3) Mixed Goals for Certain Files and/or Categories of Files:

Most carriers will have a category of files that do not have only one goal. For example, a carrier may make an effort to resolve both the workers' compensation and subrogation issues at the earliest opportunity. However, should this effort fail, the goal will then change to obtaining the maximum credit and stopping benefit payments, until the credit is exhausted. Over time, this methodology will help both the carrier and the claimant's attorney(s) understand the mutual benefits of eliminating unproductive transactional costs. Plaintiff lawyers, who typically work on a contingency basis, get paid when a case ends favorably, so the sooner the better. The workers' compensation carrier, likewise, does better in the long run by keeping transactional costs down and resolving both the workers' compensation and related subrogation issues as soon as possible.

E. Variations to the Procedures

By the end of Stage Two the carrier has identified substantial funds in previously non-disclosed settlements or funds made available to the claimants through court or out of court settlements. These newly discovered funds, which otherwise may have escaped discovery, or done so for many years, may now be called upon to serve as a basis for the carrier to seek credits applicable against future payment of workers compensation benefits, to allow large sums of money to be released from the carrier's reserved funds for use in its capital account as cash on hand, and allowing it to stop the payment of benefits directly related to the recently discovered third party funds. Where its cash on hand ratio to reserved funds is low, the carrier's ability to sell new coverage and earn new premium may have been reduced or stopped by the jurisdiction's department of insurance or other administering authority. These newly discovered funds, after credits have been taken may allow the carrier to once again start selling new or upgraded coverage, thereby increasing premium earnings. In some cases this increase to the carrier's cash account may be enough to save it from liquidation or other less severe governmental control and the litigation expenses related thereto. Where low cash on hand is not an urgent concern, discovery of third party settlement proceeds earlier in the process of the pending third party claim or third party litigation process will provide the carrier with a more advantageous bargaining position from which to resolve both its subrogation interests and obtain more beneficial resolutions of pending workers' compensation claims.

More timely discovery of millions of dollars in non-disclosed third party settlements (in and out of court, with or without trial) will allow those carriers who return dividends to their insureds based on the insured's loss record for the prior period of coverage to be able to do so more accurately, thereby increasing the benefit to their insureds and enabling the carrier to better comply with its contractual or statutory duty to do so. Reduction of the reserve account in favor of the cash account improves the general financial health of the carrier, be it a nonprofit or a for profit enterprise. Where the carrier is a for profit enterprise, its stockholders will benefit from its improved cash position and the carrier's ability to raise capital through the sale of bonds or stock, perhaps at higher offering prices, by selling bonds and/or other equity raising procedures. By reviewing the interrogatory answers and/or the subsequent claims reporting comparison approach information and then comparing them to the identity of the claims supervisors, adjusters or subrogation staff who previously managed the carrier's related workers' compensations claims files, the carrier will be better able to improve its initial screening procedures to detect third party involvement. This will allow the carrier to upgrade initial subrogation screening procedures. The methodology and system of the present invention allows the carrier to achieve these goals in previously unthought of record time, just a matter of months (perhaps days or weeks) for the initial identification of files containing third party settlements and ongoing third party claims in most cases if Stages One and Two are vigorously applied by the carrier. The present invention can accomplish this in a remarkably cost efficient manner, using information already on hand in most carrier's computers by way of a simple Boolean computer search and use of generic written interrogatories that become the subject of a mass mailing and/or the subsequent claims comparison approach. FIG. 6 sets forth a list of the initial data required for this methodology and invention from which the categories for high yield claim files containing third party settlements and ongoing claims will be extrapolated. The present invention provides key definitional terms (as words of art specifically detailed to the methodology) for such terms as Catastrophic and Mass Injury, which can easily be adjusted to allow for broadening or narrowing the basic net which discovers these previously undisclosed third party settlement funds. For example, if the $100,000 part of the definition of catastrophic injury yields $50 million in undisclosed third party settlement funds, the carrier may believe it worthwhile to adjust the bar of that definition downwards to $75,000 or less until the results become less dramatic. Where the number of 25 reported similar injuries by the same insured in one twelve month period bring a substantial yield in the discovery of settlement funds, either the number of 25 injuries may be lowered or the length of months increased until an adequate result is no longer reached. FIG. 7 sets forth an example form memorandum that can be sent to the carrier's claim adjusters or examiners to elicit information not available in the carrier's computer database. The form memorandum includes a “cc” designation to forward the missing information to the carrier's computer department for inputting into the computer database.

The carrier, in implementing Stage One and Two, should initiate a review of files (closed or open files), where the underlying workers' compensation case has been resolved by settlement or award of the workers' compensation administrative agency in its jurisdiction and should review sample each definitional category of the terms “Catastrophic and Mass Injury” and/or those Reserved for Rehabilitation (or actually awarded) in retrospective increments beginning with the shortest civil court personal injury (tort) statute of limitations period in its jurisdiction. Thereafter, the carrier's files should be sample reviewed in one or two year increments until the yield revealed in Stage Two becomes insubstantial in the carrier's judgment. For example, in Mississippi where the current personal injury statute of limitation is six years, the carrier should sample review the first six years of its resolved workers' compensation files, then go further back in time in one or two year increments until it starts obtaining, in its own judgment, insubstantial results at the end of Stage Two. In short, all viable third party claims should be triaged at the earliest possible time in this methodology to prevent related civil statutes of limitations from running.

To further refine the screening process, once the initial undisclosed settlements have been identified, for example using the categories catastrophic, mass injury and reserved for rehabilitation, the results obtained should be reviewed for significant commonality in other high yield subcategories. For example, if it turns out that within the results obtained there are an inordinately high number of settlements discovered resulting from injuries which took place on premisses not belonging to the insured's employer involving a specific type or similar types of injury, construction sites of certain types, involving the use of certain type of chemicals, or of other common nexus, then the screening process can further be narrowed by repeating Stages One and Two as to those subcategories. These steps can be applied to a representative sampling of 50 to 100 files, for example, where the files are reserved for $25,000 to $50,000. If found to be fruitful, larger numbers of interrogatories can be sent out. If not, little will have been spent in time or money to find out. Also, subcategory searches such as this may alert the carrier to cases where claimants should be advised of the existence of potential third party claims, where heretofore the carrier's own subrogation attorneys and staff have failed to identify the third party potential, or that there are third party matters which should be considered for referral, without compensation, to third party counsel specializing in handling such cases to whom the claimant's counsel can refer their clients (i.e., the carrier's claimants). An example would be where a particular brand of drain cleaner explodes when mixed with chlorine bleach, thereby causing injury to the employees of the carrier's insured. An ombudsman program which does not conflict with state bar or other ethical rules of the particular jurisdiction can be organized to accomplish this goal within the appropriate statute of limitations period if the combined risks to the carrier presented by these claims so warrant. In this way, the carrier can become proactive in encouraging individual or class action treatment of mid-range product liability third party actions if the carrier believes this to be in its best interest.

Lastly, the methodology and system of this invention provides for both a computerized and manual procedure for follow up to the initial results obtained. It presents an abbreviated, almost automated procedure (once in place) to follow up and detect subsequent unreported settlements based on the information obtained in the responses received to the first set of written interrogatories and/or from the subsequent claims reporting comparison approach in Stage Two. This obviates the need to duplicate the efforts previously made, thus bringing more efficiency without unnecessary duplicity and costs for its ongoing maintenance.

As stated above, the present workers' compensation system is a trade off between the employer's right to defend and the injured worker's right to bring potentially ruinous civil suits against his employer in exchange for an administrative law system intended to provide a more immediate, less litigious, but lower level of benefits to the injured worker. In most jurisdictions, the surer delivery of lesser benefits has been realized, however, the system grows ever more litigious, costing both employers and workers greater expense and time to reach a final claims resolution. This methodology provides monetary incentives to both claimants and carriers, especially those with long range goals, by way of encouraging the use of stipulated lien transactions to finalize claims in a reliable, secure fashion. Doing so will reduce the attendant time delay and transactional costs of litigation to this sector of industrial accident claims (those with subrogation components) benefitting both sides. This will hopefully inspire others to find similar ways to lessen the amount of litigation and delay that currently infects the entire workers' compensation system, not by reducing the benefits delivered to deserving injured workers, but by promoting a more expeditious and reliable delivery of benefits for injured workers while providing much greater and certain subrogation results to the carrier.

While there are shown and described herein certain specific alternative forms of the invention, it will be readily apparent to those skilled in the art that the application of this invention is not so limited, but is susceptible to various modifications and rearrangements without departing from the spirit and scope of the invention. In particular, it should be noted that the present invention is subject to modification with regard to key operative definitions.

What is claimed is:

1. A method of identifying a source of available funds for a workers' compensation insurance carrier, comprising the steps of:
a) selecting one or more categories of workers' compensation claims to review for said source of available funds;
b) reviewing said carrier's workers' compensation data to identify a plurality of workers' compensation claims that can be categorized within said one or more categories of workers' compensation claims, each of said plurality of workers' compensation claims having a claimant;
c) obtaining a response for said claimant in each of said plurality of workers' compensation claims, said response directed to the identification of one or more third party claims filed by said claimant;
d) collecting identifying information from said response;
e) analyzing said response to separate said response into one of two or more responsive categories based on information provided in said response, said responsive categories comprising a claim filed category and a no claim filed category;
f) collecting third party claim information from said response to each of said interrogatory questionnaires in said claim filed category; and
g) utilizing said identifying information and said third party claim information to identify said source of available funds.

2. The method of claim 1, wherein said one or more categories of workers' compensation claims is selected from the group consisting of catastrophic injury claims, mass injury claims and reserved for rehabilitation claims.

3. The method of claim 1, wherein said obtaining step comprises utilizing a subsequent claims reporting comparison approach, said subsequent claims reporting comparison approach directed to obtaining said response from one or more claims filing information sources.

4. The method of claim 3, wherein said obtaining step further comprises transmitting an interrogatory questionnaire to said claimant, said interrogatory questionnaire having one or more interrogatories seeking said response from said claimant.

5. The method of claim 1, wherein said analyzing step further separates said responses in said claim filed category into a third party funds received category or a third party claim filed category.

6. The method of claim 1, wherein each of said collecting steps utilizes a case file cover sheet to collect said identifying information and said third party claim information.

7. The method of claim 1, wherein said source of available funds is a source of reserve funds and/or a source of subrogation funds.

8. The method of claim 1 further comprising the step of:
h) applying said third party claim information to reduce said workers' compensation insurance carrier's reserve fund requirement.

9. The method of claim 1 further comprising the step of:
h) applying said third party claim information to reduce or stop payments to said claimant.

10. The method of claim 1 further comprising the step of:
h) applying said third party claim information to enter into a stipulated lien agreement between said workers' compensation insurance carrier and said claimant.

11. The method of claim 1 further comprising the step of:
h) applying said third party claim information to identify a source of subrogation recovery funds.

12. The method of claim 1 further comprising the step of:
h) applying said third party claim information to evaluate the performance of one or more employees of said workers' compensation insurance carrier.

13. The method of claim 1 further comprising the step of:
h) applying said third party claim information to reduce said workers' compensation insurance carrier's reserve fund requirement, reduce or stop payments to said claimant, enter into a stipulated lien agreement between said workers' compensation insurance carrier and said claimant, identify a source of subrogation recovery funds, evaluate the performance of one or more employees of said workers'compensation insurance carrier and/or determine why the subrogation potential was undetected.

14. A method of identifying a source of available funds for a workers' compensation insurance carrier, comprising the steps of:
a) selecting one or more categories of workers' compensation claims to review for said source of available funds, said one or more categories of workers' compensation claims selected from the group consisting of catastrophic injury claims, mass injury claims and reserved for rehabilitation claims;
b) reviewing said carrier's workers' compensation data to identify a plurality of workers' compensation claims that can be categorized within said one or more categories of workers' compensation claims, each of said plurality of workers' compensation claims having a claimant;
c) obtaining a response for said claimant in each of said plurality of workers' compensation claims, said response directed to the identification of one or more third party claims filed by said claimant, said response obtained by utilizing a subsequent claims reporting comparison approach and/or by transmitting an interrogatory questionnaire to said claimant in each of said plurality of workers' compensation claims, said subsequent claims reporting comparison approach directed to obtaining said response from one or more claims filing information sources, said interrogatory questionnaire having one or more interrogatories each seeking said response from said claimant, said one or more interrogatories directed to the identification of one or more third party claims filed by said claimant;
d) collecting identifying information from said response;
e) analyzing said response to separate said response into one of three or more responsive categories based on information provided in said response, said responsive categories comprising a third party funds received category, a third party claim filed category and a no claim filed category;
f) collecting third party claim information from said response in said third party funds received category and said third party claim filed category;
g) entering said identifying information and said third party claim information into a case file cover sheet; and
h) utilizing said identifying information and said third party claim information to identify said source of available funds.

15. The method of claim 14, wherein said interrogatory questionnaire is a previously prepared form interrogatory and said source of available funds is a source of reserve funds and/or a source of subrogation funds.

16. The method of claim 14 further comprising the step of:
l) applying said third party claim information to reduce said workers' compensation insurance carrier's reserve fund requirement, reduce or stop payments to said claimant, enter into a stipulated lien agreement between said workers' compensation insurance carrier and said claimant, to identify a source of subrogation recovery funds and/or evaluate the performance of one or more employees of said workers' compensation insurance carrier.

17. A system of identifying a source of available funds for a workers' compensation insurance carrier, comprising:
means for identifying a plurality of workers' compensation claims in one or more categories of workers' compensation claims to review for said source of available funds, said one or more categories of workers' compensation claims selected from the group consisting of catastrophic injury claims, mass injury claims and reserved for rehabilitation claims, each of said plurality of workers' compensation claims having a claimant;
means for receiving a response from said claimant in each of said plurality of workers' compensation claims regarding the identification of one or more third party claims filed by said claimant;
means for collecting identifying information and third party claim information from said response received from said claimant to separate said response into a claim filed category or a no claim filed category;
means for determining whether said third party claim information had been previously provided by said claimant to said workers' compensation insurance carrier; and
means for utilizing said identifying information and said third party claim information to identify said source of available funds.

18. The system of claim 17 further comprising means for deciding whether to apply said third party claim information to reduce said workers' compensation insurance carrier's reserve fund requirement, reduce or stop payments to said claimant, enter into a stipulated lien agreement between said workers' compensation insurance carrier and said claimant, identify a source of subrogation recovery funds, evaluate the performance of one or more employees of said workers' compensation insurance carrier and/or determine why the subrogation potential was undetected.

19. The system of claim 17, wherein said response receiving means utilizes a subsequent claims reporting comparison approach, said subsequent claims reporting comparison approach directed to obtaining said response from one or more claims filing information sources.

20. The system of claim 19, wherein said response receiving means further comprises an interrogatory questionnaire, said interrogatory questionnaire having one or more interrogatories seeking said response from said claimant.
